(19) United States
(12) Patent Application Publication
(10) Pub. No.: US 2006/0263187 A1
(43) Pub. Date: Nov. 23, 2006

(54) Method and apparatus for unloading substrate carriers from substrate carrier transport system

(75) Inventors: Robert B. Lowrance, Los Gatos, CA (US); Michael R. Rice, Pleasanton, CA (US); Martin R. Elliott, Round Rock, TX (US); Jeffrey C. Hudgens, San Francisco, CA (US); Eric A. Englhardt, Palo Alto, CA (US)

Correspondence Address: DUGAN & DUGAN, PC, 55 SOUTH BROADWAY, TARRYTOWN, NY, 10591, US

(73) Assignee: Applied Materials, Inc.

(21) Appl. No.: 11/494,902

(22) Filed: Jul. 28, 2006

Related U.S. Application Data
(62) Division of application No. 10/650,481, filed on Aug. 28, 2003.
(60) Provisional application No. 60/407,474, filed on Aug. 31, 2002.

(51) Int. Cl. B66B 17/00

(52) U.S. Cl. 414/567

(57) ABSTRACT

A substrate loading station includes a load/unload mechanism which unloads substrates or substrate carriers from a conveyor and loads substrates or substrate carriers onto the conveyor. The load/unload mechanism includes a rotary arm that rotates to match the speed of the conveyor to lift a substrate or substrate carrier off the conveyor or to lower a substrate or substrate carrier into engagement with the conveyor.

### CROSS REFERENCE TO RELATED APPLICATIONS

This application is a division of and claims priority from U.S. patent application Ser. No. 10/650,481, filed Aug. 28, 2003, which claims priority from U.S. provisional application Ser. No. 60/407,474, filed Aug. 31, 2002. Both of these applications are incorporated by reference herein in their entirety.

The present application is related to the following commonly-assigned, co-pending U.S. Patent Applications, each of which is hereby incorporated by reference herein in its entirety:

U.S. Provisional Patent Application Ser. No. 60/407,451, filed Aug. 31, 2002 and titled “System For Transporting Wafer Carriers” (Attorney Docket No. 6900/L);

U.S. Provisional Patent Application Ser. No. 60/407,339, filed Aug. 31, 2002 and titled “System For Transporting Wafer Carriers” (Attorney Docket No. 6976/L);

U.S. Provisional Patent Application Ser. No. 60/407,336, filed Aug. 31, 2002 and titled “Method and Apparatus for Supplying Wafers to a Processing Tool” (Attorney Docket No. 7096/L);

U.S. Provisional Patent Application Ser. No. 60/407,452, filed Aug. 31, 2002 and titled “End Effector Having Mechanism For Reorienting A Wafer Carrier Between Vertical And Horizontal Orientations” (Attorney Docket No. 7097/L);

U.S. Provisional Patent Application Ser. No. 60/407,337, filed Aug. 31, 2002, and titled “Wafer Loading Station with Docking Grippers at Docking Stations” (Attorney Docket No. 7099/L);

U.S. Provisional Patent Application Ser. No. 60/407,340, filed Aug. 31, 2002 and titled “Wafer Carrier having Door Latching and Wafer Clamping Mechanism” (Attorney Docket No. 7156/L);

U.S. Provisional Patent Application Ser. No. 60/443,087, filed Jan. 27, 2003 and titled “Methods and Apparatus for Transporting Wafer Carriers” (Attorney Docket No. 7163/L);

U.S. patent application Ser. No. 60/407,463, filed Aug. 31, 2002 and titled “Wafer Carrier Handler That Unloads Wafer Carriers Directly From a Moving Conveyor” (Attorney Docket No. 7676/L1).

U.S. patent application Ser. No. 60/443,004, filed Jan. 27, 2003 and titled “Wafer Carrier Handler That Unloads Wafer Carriers Directly From a Moving Conveyor” (Attorney Docket No. 7676/L2).

U.S. Provisional Patent Application Ser. No. 60/443,153, filed Jan. 27, 2003 and titled “Overhead Transfer Flange and Support for Suspending Wafer Carrier” (Attorney Docket No. 8092/L);

U.S. Provisional Patent Application Ser. No. 60/443,001, filed Jan. 27, 2003 and titled “Systems and Methods for Transferring Wafer Carriers Between Processing Tools” (Attorney Docket No. 8201/L); and

U.S. Provisional Patent Application Ser. No. 60/443,115, filed Jan. 27, 2003 and titled “Apparatus and Method for Storing and Loading Wafer Carriers” (Attorney Docket No. 8202/L)

### FIELD OF THE INVENTION

The present invention relates generally to semiconductor device fabrication systems, and is more particularly concerned with transportation of substrate carriers within a fabrication facility.

### BACKGROUND OF THE INVENTION

Manufacturing of semiconductor devices typically involves performing a sequence of procedures with respect to a substrate, such as silicon substrate, glass plate, etc. (Such substrates may also be referred to as wafers, whether patterned or unpatterned.) These steps may include polishing, deposition, etching, photolithography, heat treatment, and so forth. Usually a number of different processing steps may be performed in a single processing system or “tool” which includes a plurality of processing chambers. However, it is generally the case that other processes are required to be performed at other processing locations within a fabrication facility, and it is accordingly necessary that substrates be transported within the fabrication facility from one processing location to another. Depending upon the type of semiconductor device to be manufactured, there may be a relatively large number of processing steps required, to be performed at a considerable number of different processing locations within the fabrication facility.

It is conventional to transport substrates from one processing location to another within substrate carriers such as sealed pods, cassettes, containers and so forth. It is also conventional to employ automated substrate carrier transport devices, such as automatic guided vehicles, overhead transport systems, substrate carrier handling robots, etc., to move substrate carriers from location to location within the fabrication facility or to transfer substrate carriers from or to a substrate carrier transport device.

For an individual substrate, the total fabrication process, from formation or receipt of the virgin substrate to cutting of semiconductor devices from the finished substrate, may require an elapsed time that is measured in weeks or months. In a typical fabrication facility, a large number of substrates may accordingly be present at any given time as “work in progress” (WIP). The substrates present in the fabrication facility as WIP may represent a large investment of working capital, which tends to increase the per substrate manufacturing cost. It would therefore be desirable to reduce the amount of WIP for a given substrate throughput for the fabrication facility. To do so, the total elapsed time for processing each substrate should be reduced.

### SUMMARY OF THE INVENTION

Methods and apparatus of the present invention may provide an efficient and reliable arrangement for exchanging substrates or substrate carriers with a conveyor that may remain in motion during the exchange.

The invention provides a load/unload mechanism adapted to load and/or unload a substrate or substrate carrier onto/from a moving conveyor. In a first aspect the load/unload mechanism comprises an arm having a first end and a second end, the arm being mountable by its first end for rotation about a horizontal axis. An end effector is mounted at the second end of the arm and is adapted to support a substrate carrier. An arm moving mechanism is coupled to the arm and adapted to rotate the arm such that the end effector is lowered while substantially matching a velocity of the end effector to a velocity at which the conveyor moves.

In a second aspect the invention provides an apparatus for supplying substrates to a processing tool. The apparatus comprises a load port, and an unload mechanism adapted to unload a substrate carrier from a substrate carrier transport system. The unload mechanism includes an arm having a first end and a second end, the arm being mounted by its first end at a mounting location for rotation about a horizontal axis; and an end effector mounted at the second end of the arm and adapted to support a substrate carrier. The unload mechanism is adapted to hand off at a transfer station a substrate carrier unloaded from the substrate carrier transport system. A substrate carrier handler is adapted to transport a substrate carrier from the transfer station to the load port and a mechanism is adapted to rotate the unload mechanism such that at a time when the end effector contacts the substrates carrier, the end effector has a velocity that substantially matches a velocity of the substrate carrier while the substrate carrier is moving along the transport system.

In a third aspect the invention provides a method of unloading a substrate carrier from a moving conveyor. The method comprises transporting a substrate carrier via a conveyor, and, about a horizontal axis, rotating an arm having an end effector couple thereto. The substrate carrier is then contacted with the end effector so as to lift the substrate carrier from the conveyor while substantially matching a velocity of the end effector to a velocity at which the substrate carrier is transported by the moving conveyor.

In a forth aspect the invention comprises a method of loading a substrate carrier onto a moving conveyor. The method comprises supporting a substrate carrier via an end effector coupled to a rotatable arm, about a horizontal axis, rotating the arm, and substantially matching a velocity of the end effector to a velocity at which the conveyor moves. The substrate carrier is lowered onto the conveyor while continuing to substantially match the velocity of the end effector to the velocity of the conveyor.

Any of the above aspects may also be employed for loading/unloading individual substrates (without a carrier). Other features and aspects of the present invention will become more fully apparent from the following detailed description of exemplary embodiments, the appended claims and the accompanying drawings.

### BRIEF DESCRIPTION OF THE DRAWINGS

FIGS. 1-4 are schematic isometric views, taken at various stages of operation, of a substrate loading station that incorporates a substrate carrier load/unload mechanism provided in accordance with the invention; specifically, FIG. 1 shows the inventive load-unload mechanism immediately after unloading a substrate carrier from a moving conveyor; FIG. 2 shows the inventive load/unload mechanism supporting the substrate carrier at a transfer station; FIG. 3 shows the inventive load/unload mechanism picking up a substrate carrier from another transfer station; and FIG. 4 shows the inventive load/unload mechanism just prior to handing off a substrate carrier to the moving conveyor;

FIG. 5 is another schematic isometric view of the loading station of FIGS. 1-4, showing other features of the loading station;

FIG. 6 is a view, similar to FIGS. 1-4, of a substrate loading station which includes a substrate carrier load/unload mechanism provided in accordance with another embodiment of the invention;

FIG. 7 is a partially schematic isometric view of another substrate loading station that incorporates a substrate carrier load/unload mechanism provided in accordance with the invention;

FIG. 8 is a schematic side view of an arrangement of vertically stacked docking stations that may be incorporated in the illustrated substrate loading stations; and

FIG. 9 is a schematic isometric view of a substrate carrier door opening arrangement that may be incorporated in one or more of the docking stations shown in the drawings.

### DETAILED DESCRIPTION

Commonly-assigned, co-pending patent application Ser. No. 60/407,451, filed Aug. 31, 2002 entitled “System for Transporting Wafer Carriers” (Attorney Docket No. 6900) discloses a substrate carrier transport system that includes a conveyor for substrate carriers that may be constantly in motion during operation of the fabrication facility which it serves. The constantly moving conveyor may reduce the total “dwell” time of each substrate in the fabrication facility, thereby reducing WIP, and cutting capital and manufacturing costs. To operate a fabrication facility in this manner, it is necessary to provide a suitable mechanism to unload substrate carriers from the conveyor, and to load substrate carriers onto the conveyor, while the conveyor is in motion.

The present invention provides a mechanism which may unload substrate carriers from, and load substrate carriers onto, a substrate carrier conveyor while the substrate carrier conveyor is moving. The inventive load/unload mechanism includes a rotary arm that is adapted to (a) engage a vertically-oriented substrate carrier that is being transported by the conveyor; (b) disengage the substrate carrier from the conveyor; and (c) deliver the vertically-oriented substrate carrier to a transfer station. At the transfer station the vertically-oriented substrate carrier may be picked up by a substrate carrier handling robot (also known as a “substrate carrier handler”) and then manipulated and transported so as to be presented to a docking station of a substrate loading station. The inventive load/unload mechanism may also to pick up a vertically-oriented substrate carrier from a transfer station and to hand off the vertically-oriented substrate carrier to the moving conveyor. Although the invention is particularly well suited to handling vertically oriented substrates, and particularly those adapted to transport single substrates, the invention may be employed with substrate carriers of any orientation or size. Accordingly, although the exemplary embodiment provided herein is directed to a vertically oriented single substrate carrier, the invention is not limited thereto.

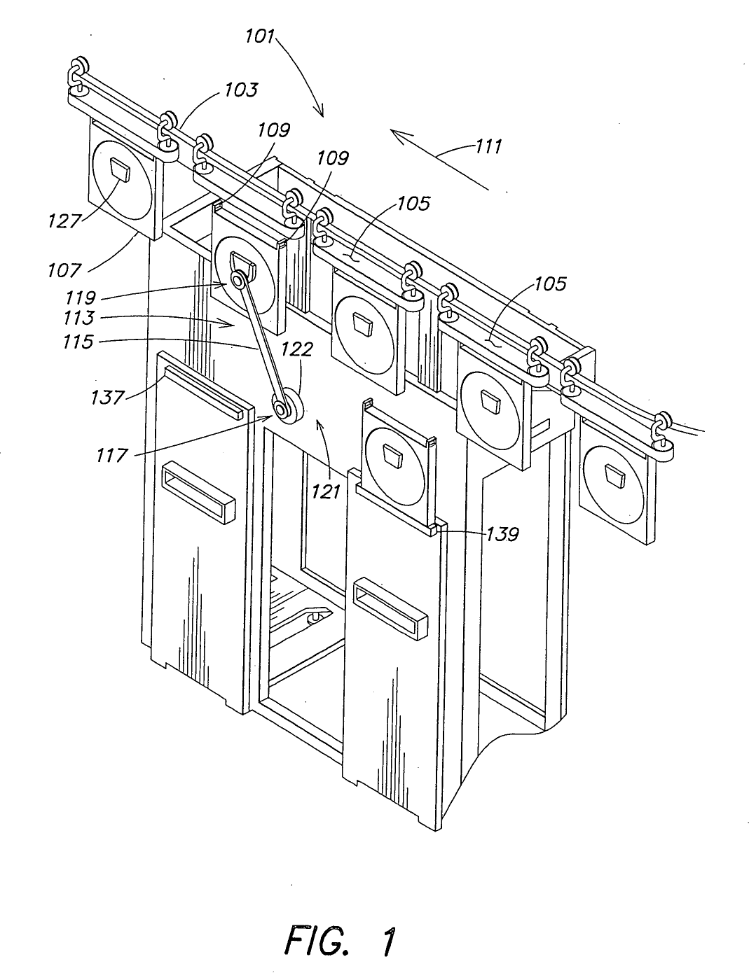

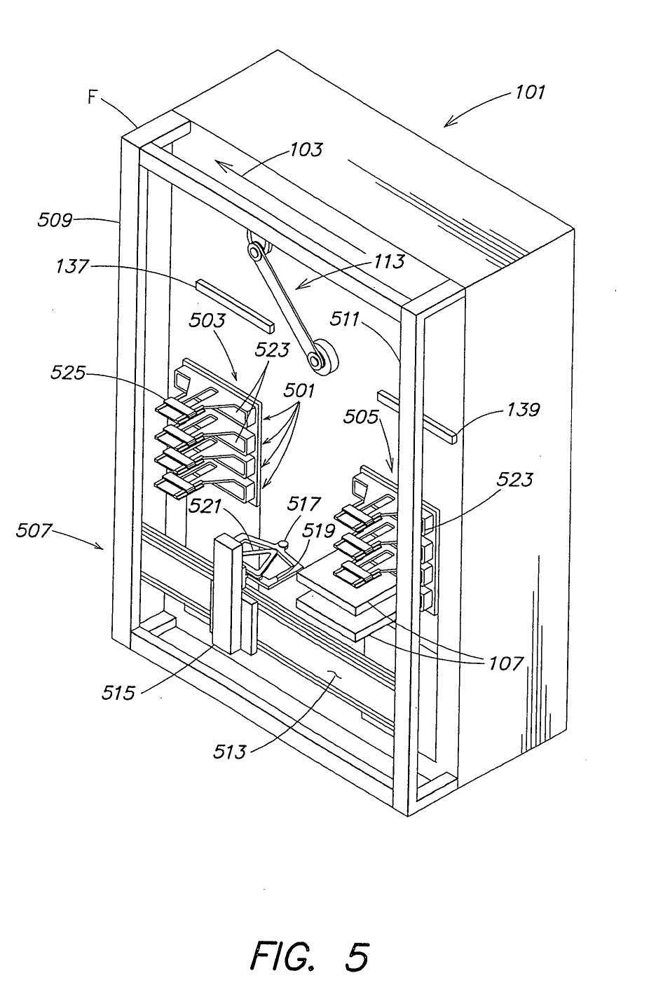

A first embodiment of the invention will now be described with reference to FIGS. 1-5. FIGS. 1-4 are isometric schematic views showing various stages of operation of an inventive substrate loading station 101. FIG. 5 is an isometric schematic view showing additional features of the inventive substrate loading station 101.

Although not shown in the drawings, a conventional substrate processing tool may be installed behind the substrate loading station 101. A conveyor 103 or other factory transport system passes by the substrate loading station 101 at an elevation above the substrate loading station 101. According to an aspect of the invention, the conveyor 103 may be continuously operated while the semiconductor fabrication facility is in operation. This may lead to more efficient transportation of substrates through the fabrication facility, reduction of work-in-progress, and lower per substrate manufacturing cost. The factory transport system (e.g., the conveyor 103) may include a series of suspension assemblies 105, each of which is adapted to support a respective substrate carrier 107 in a vertical orientation. For example, slots 109 may be provided at a leading and a trailing end of the substrate carriers 107 to allow the substrate carriers 107 to be engaged by hooks (not separately shown) of the suspension assemblies 105. The conveyor 103 transports the substrate carriers 107 in a direction indicated by arrow 111.

In one embodiment of the invention, each substrate carrier 107 is a single substrate carrier, i.e., a substrate carrier in which one and only one substrate is held at a time. The substrate carrier may have some or all of the features disclosed in commonly-assigned, co-pending patent application Ser. No. 60/407,340, filed Aug. 31, 2002, entitled “Wafer Carrier Having Door Latching and Wafer Clamping Mechanisms” (Attorney Docket No. 7156), which is incorporated herein by reference.

Because the conveyor 103 may be continuously in motion, delivery of substrate carriers 107 to the substrate loading station 101 may require that the substrate carriers 107 be loaded onto, and unloaded from, the conveyor 103 while the conveyor 103 is in motion. The inventive load/unload mechanism 113 may be employed to load/unload substrate carriers that are moving along a factory transport system such as a continuously moving conveyor.

The inventive load/unload mechanism 113 includes a rotary arm 115 which has a first end 117 and a second end 119. The rotary arm 115 is mounted by its first end 117 at a mounting location 121 for rotation about a horizontal axis. A motor 122 may be provided at the mounting location 121 and may be coupled to the first end 117 of the rotary arm 115 to impart rotational motion to the rotary arm 115 (e.g., in a counter-clockwise direction, as viewed in FIGS. 1-4). It will be noted that in the exemplary embodiment of FIG. 1, the mounting location 121 is below the conveyor 103 and the axis of rotation of the rotary arm 115 is substantially transverse to the direction of travel of the conveyor. A controller, which is not shown, is provided to control the motor 122 and may rotate the rotary arm 115 at varying speeds to perform the load/unload and substrate carrier transfer functions which are described below.

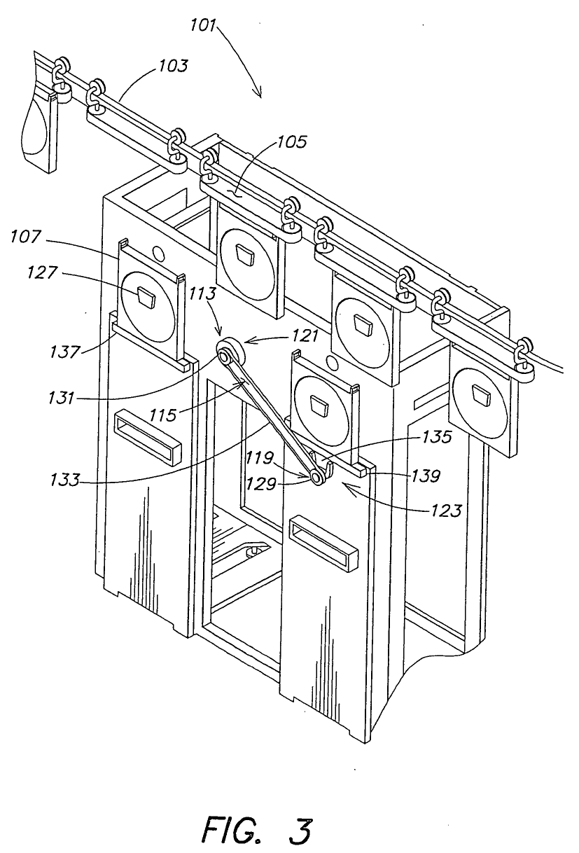

As best seen in FIG. 3, an end effector 123 is mounted at the second end 119 of the rotary arm 115. The end effector 123 is mounted so as to be free to rotate about a horizontal axis (parallel to the axis of rotation of the rotary arm 115) relative to the second end 119 of the rotary arm 115. The end effector 123 may be cup-shaped (i.e., having one side that is open to receive a flange or other portion of a substrate carrier, while the remaining sides capture and support the flange or other portion) and adapted to support a substrate carrier 107 to be unloaded from, or loaded onto, the conveyor 103. In particular, the end effector 123 is adapted to engage a feature 127 (such as an overhead transfer flange) provided on a side of the substrate carrier 107.

In an exemplary embodiment, a rotatable pulley 129 is mounted at the second end 119 of the rotary arm 115 in such a fashion as to be in fixed relation to the end effector 123 and rotatable relative to the second end 119 of the rotary arm 115 together with, and about the same axis as, the end effector 123. A fixed pulley 131 is fixedly mounted at the mounting location 121 and is positioned coaxially with the axis of rotation of the rotary arm 115 and extends outwardly from the mounting location 121 past the first end 117 of the rotary arm 115. A belt 133 engages both the rotatable pulley 129 and the fixed pulley 131. The pulleys 129, 131 and the belt 133 together constitute a constraining mechanism which constrains the end effector 123 to have a fixed orientation relative to the frame of reference of the loading station 101 as the rotary arm 115 rotates. In particular, it will be observed that the orientation of the end effector 123 is such that an open side 135 of the end effector 123 is oriented upwardly. It will also be appreciated that the end effector 123 is constrained to have a fixed orientation (e.g., with the open side 135 oriented upwardly) relative to the conveyor. Any other suitable constraining mechanism may be similarly employed.

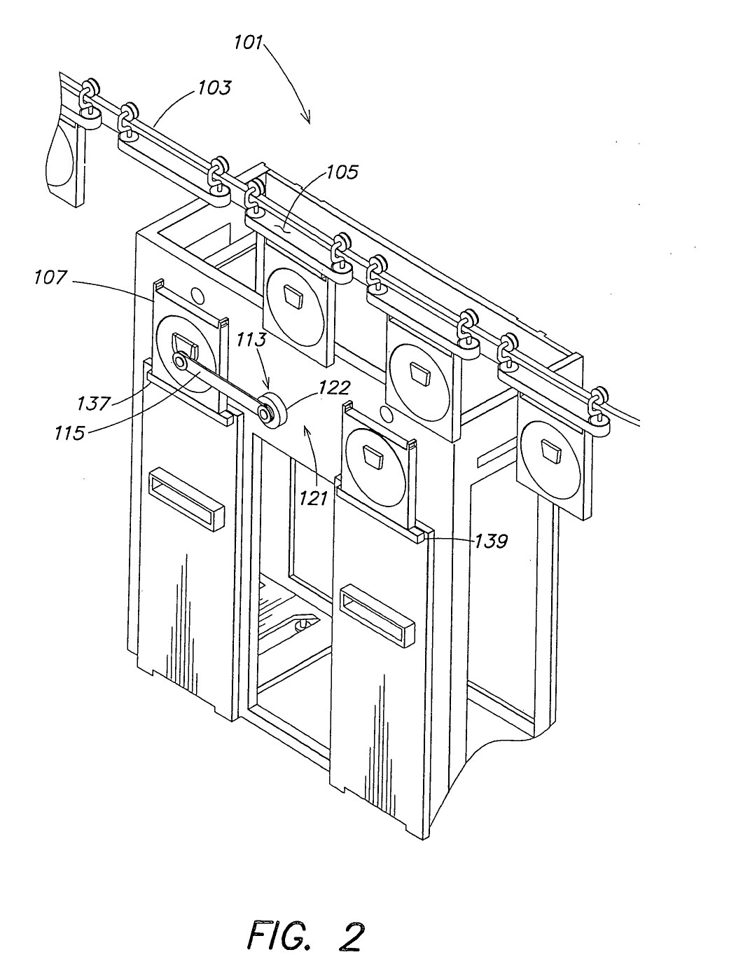

The load/unload mechanism 113 is adapted to hand off a substrate carrier 107 at a first transfer station 137 and to pick up a substrate carrier 107 at a second transfer station 139. Each of the transfer stations 137, 139 may be constituted by a respective shelf (not separately shown) that is adapted to support a substrate carrier 107 (e.g., while allowing the end effector to pass therethrough so as to pick or place a substrate carrier from or on the shelf). Alternatively, the transfer stations 137, 139 may simply be locations in space at which the load/unload mechanism 113 exchanges a substrate carrier 107 with a substrate carrier handler (not shown in FIGS. 1-4) that is associated with the substrate loading station 101. It will be observed that the transfer locations 137, 139 may be at substantially the same elevation as the mounting location 121, such that the rotary arm 115 is substantially in a horizontal orientation when handing off a substrate carrier 107 (FIG. 2) at the first transfer station 137 or picking up a substrate carrier 107 at the second transfer station 139.

FIG. 5 shows additional features of the inventive substrate loading station 101. In FIG. 5, the conveyor 103 and the inventive load/unload mechanism 113 are schematically represented. As seen in FIG. 5, the substrate loading station 101 also includes a plurality of docking stations 501. In the particular embodiment shown in FIG. 5, the substrate loading station 101 includes a total of eight docking stations 501, arranged in two vertically-stacked groups 503, 505 of four docking stations each. Each docking station 501 is adapted to dock a substrate carrier 107 at the docking station 501 and to allow a substrate (not shown) to be extracted from the substrate carrier 107 at the docking station 501 and transferred to the processing tool (not shown) to which the substrate loading station 101 is coupled. The inventive substrate loading station 101 may be, except for the presence of the load/unload mechanism 113, any station wherein a substrate or substrate carrier is received from factory transport and transported to a load port (i.e., a location from which substrates may be loaded to and unloaded from a processing tool). An exemplary loading station is the Applied Materials Bay Distributed Stocker.

The substrate loading station 101 also includes a substrate carrier handler 507. The substrate carrier handler 507 is adapted to transfer substrate carriers 107 between the transfer stations 137, 139 and the docking stations 501. The substrate carrier handler 507 may include a pair of vertical guides 509, 511 and a horizontal guide 513 which is mounted for vertical movement on the vertical guides 509, 511. A support 515 is mounted on the horizontal guide 513 for horizontal movement along the horizontal guide 513, and an end effector 517 is mounted on the support 515. In one aspect, the end effector 517 may be in the form of a platform 519 adapted to support a substrate carrier 107. A reorientation mechanism 521, of the type disclosed in the above-referenced patent application Ser. No. 60/407,452, filed Aug. 31, 2002 (Attorney Docket No. 7097), may be associated with the end effector 517. The reorientation mechanism 521 is adapted to reorient a substrate carrier 107 supported on the end effector 517 between a vertical orientation and a horizontal orientation.

Each docking station 501 may include a port 523 and a docking gripper 525. The docking gripper 525 is adapted to suspend a substrate carrier 107 and to move the suspended substrate carrier between a docked and undocked position. Alternatively, a docking platform may be employed to move a substrate carrier between docked and undocked positions. Each docking station 501 also includes a substrate carrier door opener, which is not shown in FIG. 5, but which will be discussed below.

In operation, the conveyor 103 may continuously transports substrate carriers 107 from location to location within the fabrication facility. When a substrate carrier 107 is to be delivered to the substrate loading station 101, the rotary arm 115 of the load/unload mechanism 113 is rotated by the motor 122 along an upward arc, such that the end effector 123 has a horizontal velocity component that substantially matches the velocity at which the substrate carrier 107 is transported by the conveyor 103. The matching of the velocity of the end effector 123 to the velocity of the substrate carrier 107 that is to be delivered to the substrate loading station 101 occurs near the top of the path of the end effector 123. The end effector 123, and particularly the end effector 123, continues to be raised while matching the horizontal velocity of the substrate carrier 107 and comes into engagement with the feature 127 of the substrate carrier 107. The substrate carrier 107 is lifted by the end effector 123 out of engagement with the corresponding suspension assembly 105 of the conveyor 103 and then the rotary arm 115 is decelerated, allowing the suspension assembly 105 to move ahead of the substrate carrier 107. The rotary arm 115 then proceeds on its downward arc.

FIG. 1 shows the substrate loading station 101 at a point in its operation shortly after a substrate carrier 107 has been transferred from the conveyor 103 to the load/unload mechanism 113. The load/unload mechanism 113 then carries the substrate carrier 107 to the first transfer station 137, as illustrated in FIG. 2. At the first transfer station 137, the substrate carrier 107 may be transferred to a shelf (if present) to be later extracted by the substrate carrier handler 507 (FIG. 5). Alternatively, the substrate carrier 107 may be transferred directly from the load/unload mechanism 113 to the substrate carrier handler 507. In such a case, the rotary arm 115 may be held stationary in the substantially horizontal position indicated in FIG. 2, and the substrate carrier handler 507 may operate such that the end effector 517 (FIG. 5) of the substrate carrier handler 507 lifts the substrate carrier 107 from engagement with the end effector 123 (FIG. 2) of the load/unload mechanism 113. Alternatively the end effector of the substrate carrier handler may extend into position so as to intersect the load/unload mechanism 113's path, and then may remain stationary as the load/unload mechanism 113 rotates therethrough to hand off a substrate carrier to the substrate carrier handler 507.

In any case, the rotary arm 115 may now be further rotated in a downward arc to, for example, a rest position in which the rotary arm 115 extends vertically downwardly from the mounting location 121.

Once the substrate carrier 107 is supported on the end effector 517 of the substrate carrier handler 507, the end effector 517 may reorient the substrate carrier 107 from a vertical orientation to a horizontal orientation (e.g., using a motorized flipper coupled to the end effector 517), as disclosed in the above-referenced patent application Ser. No. 60/407,452, filed Aug. 31, 2002 (Attorney Docket No. 7097). The reoriented substrate carrier 107 is then moved by the substrate carrier handler 507 to a position between the columns 503, 505 of docking stations 501 (FIG. 5), and at the height of the particular one of the docking stations 501 to which the substrate carrier 107 is to be docked. The substrate carrier handler 507 then moves the substrate carrier 107 laterally (horizontally) until the substrate carrier 107 is juxtaposed with the docking gripper 525 of the particular docking station 501. The substrate carrier handler 507 then lowers the substrate carrier 107 a short distance so that a suitable feature of the substrate carrier 107 (which may be the feature 127 or a separate flange, which is not shown) is engaged by the docking gripper 525. The end effector 517 of the substrate carrier handler 507 may then be moved to a home position, such as the position shown in FIG. 5.

The docking gripper 525 then imparts a docking movement to the substrate carrier 107 engaged by the docking gripper 525. That is, the docking gripper 525 moves the substrate carrier 107 toward the port 523 of the docking station 501. As will be described below, either during or after the docking movement, a substrate carrier opener (not shown in FIG. 5) opens a door (not shown) of the substrate carrier 107.

After the substrate carrier 107 is docked at the port 523 and has been opened, a substrate handling robot (not separately shown) extracts a substrate from the substrate carrier 107 and transfers the substrate to the processing tool which is associated with the substrate loading station 101. The processing tool performs one or more processes on the substrate. When the processing of the substrate is complete, the substrate is transferred by the substrate handling robot from the processing tool and is reinserted in the substrate carrier 107. The substrate carrier 107 is then undocked from the port 523 by the docking gripper 525. Closing of the substrate carrier 107 may be accomplished before or simultaneously with undocking.

The end effector 517 of the substrate carrier handler 507 is then brought to a position just below the undocked substrate carrier 107. The end effector 517 of the substrate carrier handler 507 is then raised a small amount to disengage the substrate carrier 107 from the docking gripper 525. The substrate carrier handler 507 then moves the substrate carrier 107 laterally (horizontally) away from the docking station 501 and into a position between the columns 503, 505 of docking station 501. The substrate carrier 107 can then be transported by the substrate carrier handler 507 to the second transfer station 139.

At the second transfer station 139, the substrate carrier 107 containing the processed substrate is picked up by the load/unload mechanism 113. FIG. 3 shows the rotary arm 115 of the load/unload mechanism 113 positioned below the second transfer station 139 such that the end effector 123 of the load/unload mechanism 113 can be raised to engage the feature 127 of the substrate carrier 107 at the second transfer station 139. As discussed in connection with the first transfer station 137, the second transfer station 139 may be a shelf adapted to support a substrate carrier 107, or may simply be a position at which the end effector 517 (FIG. 5, not shown in FIG. 3) of the substrate carrier handler 507 holds the substrate carrier 107 for transfer to the load/unload mechanism 113. The load/unload mechanism 113 is rotated so as to lift the substrate carrier 107 from the second transfer station 139 via the end effector 123 of the load/unload mechanism 113.

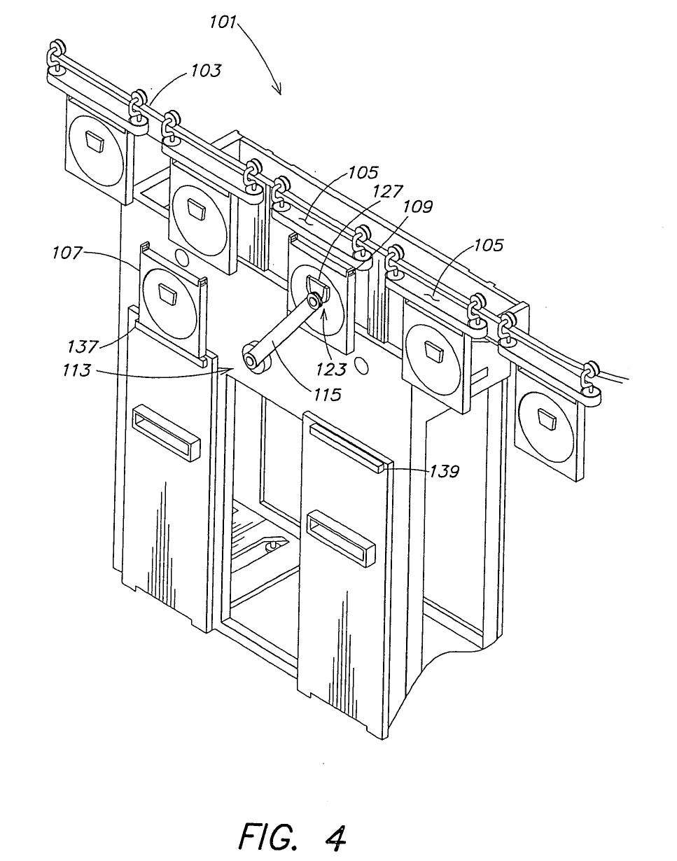

FIG. 4 shows the rotary arm 115 of the load/unload mechanism 113 raising a substrate carrier 107 to approach a suspension assembly 105 of the conveyor 103 to which the substrate carrier 107 is to be engaged. At or near the top of the arc described by the end effector 123 of the load/unload mechanism 113, the substrate carrier 107 is moved at a velocity having a horizontal component (e.g., a horizontal speed) that substantially matches the horizontal velocity component (e.g., horizontal speed) of the conveyor 103. While at the substantially matching velocity, the load/unload mechanism 113 lowers the end effector 123 such that the substrate carrier 107 is lowered to come into engagement with the suspension assembly 105 of the conveyor 103. The end effector 123 continues to be lowered, so that the substrate carrier 107 is disengaged from the end effector 123 and is carried away by the conveyor 103. The conveyor 103 then transports the substrate carrier 107 to another location in the fabrication facility.

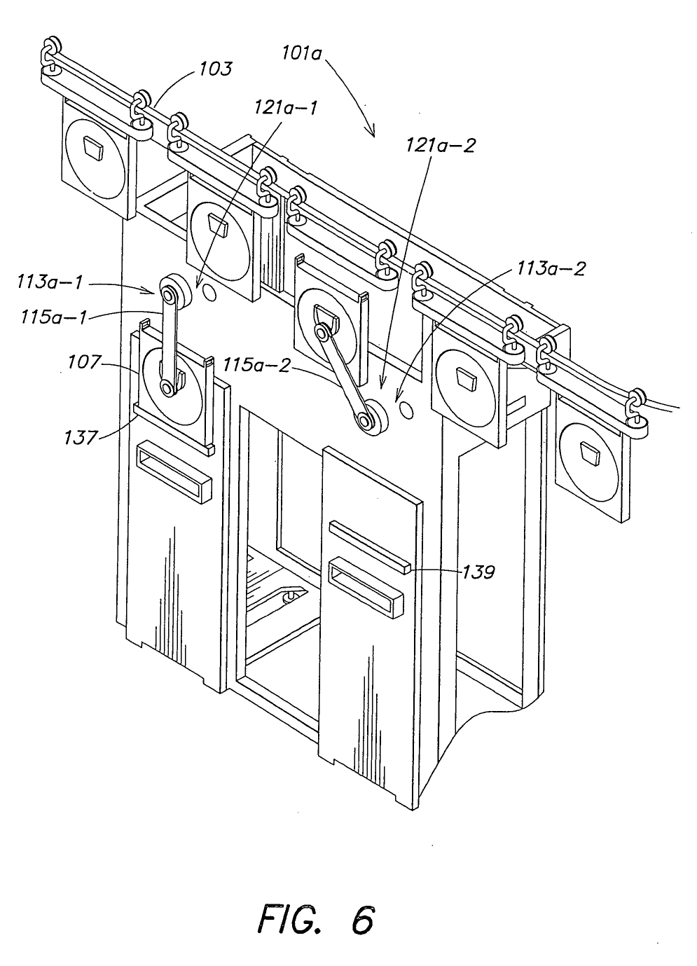

FIG. 6 is a schematic isometric view of a substrate loading station 101a provided in accordance with another embodiment of the invention. The substrate loading station 101a of FIG. 6 differs from the substrate loading station 101 of FIGS. 1-4 essentially in that the substrate loading station 101a of FIG. 6 has two load/unload mechanisms 113a-1 and 113a-2. The load/unload mechanisms 113a-1, 113a-2 of the embodiment of FIG. 6 may be substantially the same as the load/unload mechanism 113 shown in FIGS. 1-4, except that the rotary arms 115a-1, 115a-2 of the load/unload mechanisms 113a-1, 113a-2 may be shorter than the rotary arm 115 of the load/unload mechanism 113 of FIGS. 1-4. The load/unload mechanism 113a-1 serves only the first transfer station 137, and the load/unload mechanism 113a-2 serves only the second transfer station 139. The mounting location 121a-1 of the load/unload mechanism 113a-1 may be substantially vertically above the transfer station 137. The mounting location 121a-2 of the load/unload mechanism 113a-2 may be substantially vertically above the second transfer station 139. The load/unload mechanism 113a-1 operates so as to both deliver substrate carriers 107 to the first transfer station 137 and to pick up substrate carriers 107 from the first transfer station 137. The load/unload mechanism 113a-2 both delivers substrate carriers 107 to the second transfer station 139 and picks up substrate carriers 107 from the second transfer station 139. Thus, in the substrate loading station 101a shown in FIG. 6, substrate carriers 107 can be either delivered to or picked up from both of the first and second transfer stations 137, 139. By contrast, in the substrate loading station 101 of FIGS. 1-5, substrate carriers 107 can be received only at the first transfer station 137 and are picked up only at the second transfer station 139. Except for this difference, the substrate loading station 101a of FIG. 6 may operate in substantially the same manner as the substrate loading station 101 of FIGS. 1-5.

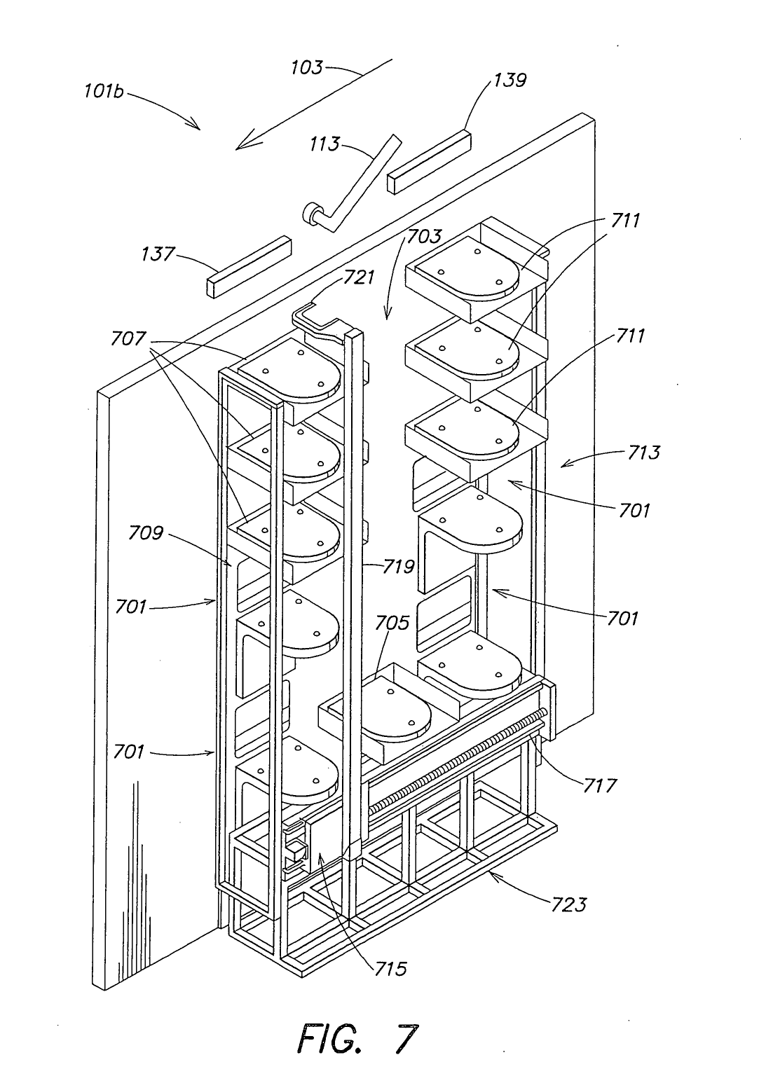

FIG. 7 is a schematic isometric view of a substrate loading station 101b provided in accordance with still another embodiment of the invention. The substrate loading station 101b may be associated with the same conveyor 103 and may include the same load/unload mechanism 113 and the same transfer stations 137, 139 as were illustrated in FIGS. 1-4. Alternatively, the transfer stations 137, 139 may include substrate carrier reorienting mechanisms of the type disclosed in the above-referenced co-pending patent application Ser. No. 60/407,452, filed Aug. 31, 2002 (Attorney Docket No. 7097). Except for the presence of elements 103, 113, 137 and 139, the substrate loading station 101b may be like a loading station disclosed in commonly-assigned co-pending patent application Ser. No. 09/527,092, filed Mar. 16, 2000 and entitled “Apparatus for Storing and Moving a Cassette” (Attorney Docket No. 4516), which is incorporated herein by reference.

The substrate loading station 101b of the embodiment of FIG. 7 includes four docking stations 701 arranged in two columns of two docking stations each. The two columns of docking stations are spaced apart from each other by a space 703 through which substrate carriers (not shown in FIG. 7) may be moved in a vertical direction. At the bottom of the vertical space 703 is a load port 705. A first vertical column of storage shelves 707 is positioned vertically above the left-hand column 709 of docking stations 701. A second vertical column of storage shelves 711 is located vertically above the right-hand column 713 of docking stations 701. The load port 705 is optional, as is the specific number and arrangement of docking stations 701 and/or storage shelves 707.

The substrate loading station 101b of FIG. 7 also includes a substrate carrier handler 715 which is adapted to transfer substrate carriers among the transfer stations 137, 139, the docking station 701, the optional load port 705 and the storage shelves 707, 711. The substrate carrier handler 715 may include a horizontal guide 717 and a vertical guide 719 mounted for horizontal movement along the horizontal guide 717. The substrate carrier handler 715 also includes an end effector 721 adapted to engage a substrate carrier (not shown) and which may be mounted for vertical movement along the vertical guide 719.

The substrate loading station 101b includes a frame 723 which may support the substrate carrier handler 715, the shelves 707, 711, the transfer stations 137, 139 and the load/unload mechanism 113.

The substrate loading station 101b of FIG. 7 may operate generally in the same manner as the substrate loading station 101 of FIGS. 1-5.

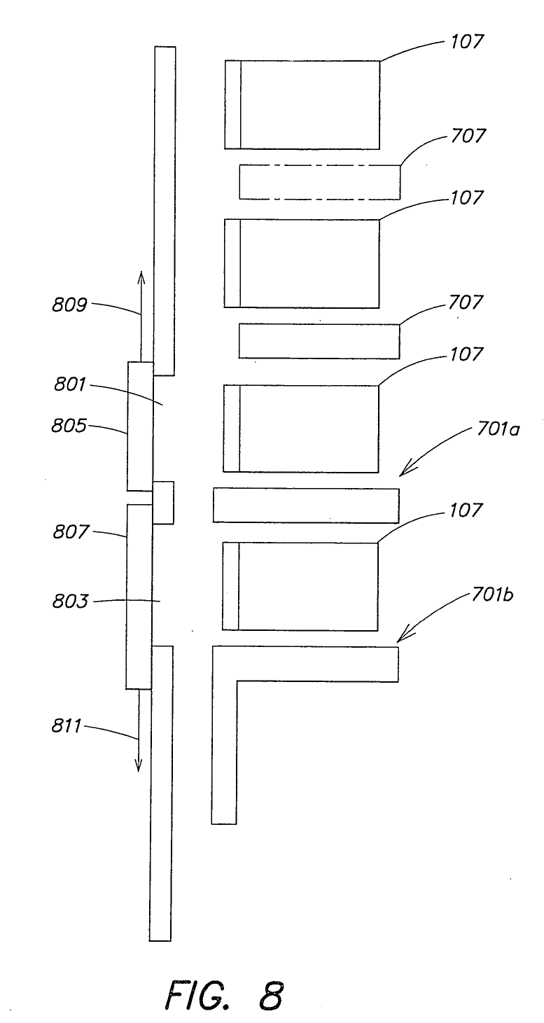

FIG. 8 is a schematic side view of a portion of a substrate loading station 101c that may be similar to the substrate loading station 101b. The substrate loading station 101c includes vertically stacked docking stations 701a and 701b, with the docking station 701a being located above the docking station 701b. Storage shelves 707 are positioned above the docking stations 701a and 701b. The upper docking station 701a includes a port 801 and the lower docking station 701b includes a port 803. A substrate carrier door receiver 805 closes the port 801 of the upper docking station 701a, and a substrate carrier door receiver 807 closes the port 803 of the lower docking station 701b. Each substrate carrier door receiver may include mechanisms for unlocking a substrate carrier door and for latching the substrate carrier door to the substrate carrier door receiver as is known in the art. As schematically indicated at 809, the port door 805 associated with the upper docking station 701a may open upwardly. As schematically indicated at 811, the port door 807 associated with the lower docking station 701b may open downwardly.

It is alternatively contemplated that both of the port doors 805, 807 may open upwardly, or both may open downwardly.

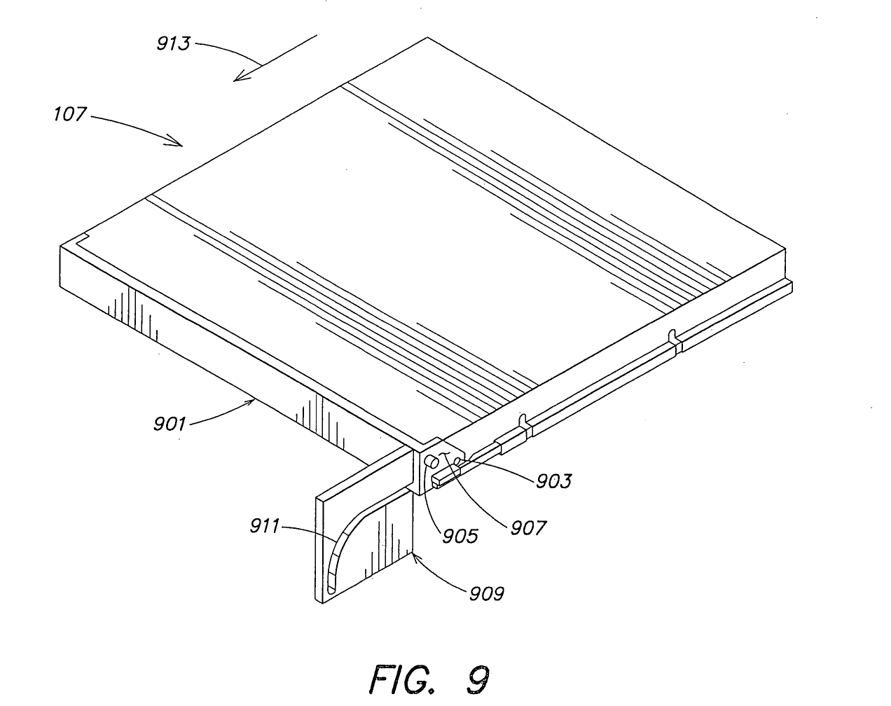

FIG. 9 is a schematic isometric view of a substrate carrier door opener that may be associated with any one of the docking stations 501, 701 referred to above. In FIG. 9, reference numeral 107 generally indicates a substrate carrier. The substrate carrier 107 has a door 901 which is hinged at 903 to open downwardly. A cam follower 905 is provided on a side 907 of the door 901. A door opener 909 (schematically illustrated) is associated with a docking station (not shown in FIG. 9). The door opener 909 includes a cam slot 911. As the substrate carrier 107 is docked (i.e., moved in the direction indicated by an arrow 913) the cam follower 905 associated with the door 901 of the substrate carrier 107 enters the cam slot 911 and is guided downwardly, thereby causing the door 901 to be opened. A more detailed description of the substrate carrier 107 and the door opener 909 shown in FIG. 9 may be found in commonly-assigned co-pending patent application Ser. No. 60/407,339, filed Aug. 31, 2002, entitled “Method and Apparatus for Using Wafer Carrier Movement to Actuate Wafer Carrier Door Opening/Closing” (Attorney Docket No. 6976), which is incorporated herein by reference.

The foregoing description discloses only exemplary embodiments of the invention; modifications of the above disclosed apparatus and methods which fall within the scope of the invention will be readily apparent to those of ordinary skill in the art. For example, the present invention is illustrated with respect to single substrate carriers, but is not limited thereto.

As illustrated herein, the rotary arm 115 of the load/unload mechanism 113 extends only from the mounting location 121 to the end effector 123. However, the rotary arm could extend past the mounting location (i.e., in the direction opposite to the end effector), e.g., for the purpose of counter-weighting. The rotary arm may also extend past the end effector. Accordingly, as used in the appended claims, the “first end” of an arm shall be understood to include any point along the arm at which the arm is mounted to a mounting location. Also, as used in the appended claims, the “second end” of an arm shall be understood to include any point along the arm at which an end effector is mounted.

The particular embodiments of substrate loading stations illustrated above include plural docking stations arranged in a plurality of vertical stacks. However, the above-illustrated substrate loading stations may be modified so as to include only one vertical stack of docking stations, or only one docking station.

While the rotary arm load/unload mechanisms disclosed herein are particularly well suited to handling vertically-oriented substrate carriers, the inventive load/unload mechanisms may be employed with horizontally-oriented substrate carriers.

It should also be understood that a substrate loading station provided in accordance with the invention may include no storage shelves, or any convenient number of storage shelves. The storage shelves, if provided, may be configured in one vertical stack, or in two or more vertical stacks, or may not be vertically stacked. Any individual storage shelves or vertical stacks of storage shelves that may be provided can be positioned vertically above one or more docking stations, or horizontally offset from the locus of the docking station or docking stations.

In the substrate loading stations illustrated herein, the conveyor and the load/unload mechanism or mechanisms are positioned above the docking stations. However, it is also contemplated that the conveyor and the load/unload mechanism or mechanisms be positioned at or below the height of the docking stations. Furthermore, the load/unload mechanism or mechanisms are shown below the conveyor, but could alternatively be positioned above the conveyor.

Substrate loading stations have been illustrated herein having one or two rotary arm load/unload mechanisms. It is, however, also contemplated that a loading station may have three or more rotary arm load/unload mechanisms.

The substrate loading stations illustrated herein may be utilized to provide substrates to a processing tool, a metrology location, or any other location or device to which a substrate may be transported in a substrate carrier. Note that instead of docking stations, which employ a docking movement (toward and away from the processing tool), loading platforms that merely support a substrate or substrate carrier may be employed. Also, door opening and closing functions are an option. It should be noted that the inventive loading apparatus also may be adapted to transfer and handle individual substrates without carriers.

Preferably, the inventive rotary arm is employed within a substrate loading station that comprises a frame (or a plurality of frames that interface with each other) such as frame F in FIG. 5, to which the vertical and horizontal guides are coupled. In this manner, the preferred substrate loading station is modular and may be quickly installed and calibrated. In the event the substrate loading station includes one or more storage shelves (not shown), each storage shelf also may be mounted on the frame. By mounting both the substrate carrier handler and the storage shelf or shelves to the frame, the substrate carrier handler and storage shelves have a predetermined position relative to each other. The load/unload mechanism 113 and/or the transfer stations 137, 139 similarly may be mounted on the frame. This further facilitates installation and calibration, and is another advantage of employing a modular substrate loading station.

In one aspect, the frame F may be mounted to predetermined mounting locations (e.g., predrilled bolt holes, etc.) on a clean room wall, or on the front wall of a chamber (e.g., a factory interface chamber). Preferably, the wall also has predetermined mounting locations to which the docking grippers or docking platforms are mounted. Additionally, the wall may have predetermined mounting locations to which a substrate carrier opening mechanism may be mounted. When two or more of the frame, the docking mechanisms, and the substrate carrier opening mechanism are each mounted to predetermined locations on the same surface, the relative positions of each are predetermined, and installation and calibration of the substrate loading station 101 is facilitated.

Accordingly, while the present invention has been disclosed in connection with exemplary embodiments thereof, it should be understood that other embodiments may fall within the spirit and scope of the invention, as defined by the following claims.

The invention claimed is:

1. A load/unload mechanism adapted to load a substrate carrier onto a moving conveyor, the load mechanism comprising:
an arm having a first end and a second end, the arm being mountable by its first end for rotation about a horizontal axis;
an end effector mounted at the second end of the arm and adapted to support the substrate carrier; and
an arm moving mechanism coupled to the arm and adapted to rotate the arm such that the end effector is lowered while substantially matching a velocity of the end effector to a velocity at which the conveyor moves.

2. The load mechanism of claim 1, wherein the horizontal axis is substantially transverse to a direction of travel of the conveyor.

3. The load mechanism of claim 1, wherein the end effector is cup-shaped.

4. The load mechanism of claim 3, further comprising a constraining mechanism adapted to constrain the end effector to have a fixed orientation as the arm rotates.

5. The load mechanism of claim 4, wherein the fixed orientation of the end effector is such that an open side of the cup-shaped end effector is oriented upwardly.

6. The load mechanism of claim 4, wherein the constraining mechanism includes:
a first pulley at the first end of the arm and fixedly mounted relative to a mounting location of the arm;
a second pulley at the second end of the arm, the second pulley being fixedly coupled to the cup-shaped end effector and rotationally mounted relative to the arm; and
a belt that engages both the first pulley and the second pulley.

7. The load mechanism of claim 1, wherein the load member is configured to support the substrate carrier in a vertical orientation.

8. An apparatus for supplying substrates to a processing tool, comprising:
a load port;
an unload mechanism adapted to unload a substrate carrier from a substrate carrier transport system, the unload mechanism including:
an arm having a first end and a second end, the arm being mounted by its first end at a mounting location for rotation about a horizontal axis; and
an end effector mounted at the second end of the arm and adapted to support the substrate carrier;
the unload mechanism being adapted to hand off at a transfer station a substrate carrier unloaded from the substrate carrier transport system;
a substrate carrier handler adapted to transport a substrate carrier from the transfer station to the load port; and
a mechanism adapted to rotate the unload mechanism such that at a time when the end effector contacts the substrates carrier, the end effector has a velocity that substantially matches a velocity of the substrate carrier while the substrate carrier is moving along a conveyor.

9. The apparatus of claim 8 wherein the load port is adapted to dock a substrate carrier.

10. The apparatus of claim 8 further comprising at least one storage shelf for storing substrate carriers, and wherein the substrate carrier handler is further adapted to transport a substrate carrier to and from the at least one storage shelf.

11. A load/unload mechanism adapted to load a substrate onto a moving conveyor, the load mechanism comprising:
an arm having a first end and a second end, the arm being mountable by its first end for rotation about a horizontal axis;
an end effector mounted at the second end of the arm and adapted to support the substrate; and
an arm moving mechanism coupled to the arm and adapted to rotate the arm such that the end effector is lowered while substantially matching a velocity of the end effector to a velocity at which the conveyor moves.

12. A load/unload mechanism adapted to load a substrate onto a moving conveyor, the load/unload mechanism comprising:
an arm having a first end and a second end, the arm being mountable by its first end for rotation about a horizontal axis;
an end effector mounted at the second end of the arm and adapted to support the substrate; and
an arm moving mechanism coupled to the arm and adapted to rotate the arm such that the end effector is lowered while substantially matching a velocity of the end effector to a velocity at which the conveyor moves.

13. A load/unload mechanism adapted to load a substrate onto a moving conveyor, the load mechanism comprising:
an arm having a first end and a second end, the arm being mountable by its first end for rotation about a horizontal axis;
an end effector mounted at the second end of the arm and adapted to support the substrate; and
an arm moving mechanism coupled to the arm and adapted to rotate the arm such that the end effector is lowered while substantially matching a velocity of the end effector to a velocity at which the conveyor moves.
